(19) United States
(12) Patent Application Publication
(10) Pub. No.: US 2010/0241738 A1
(43) Pub. Date: Sep. 23, 2010

(54) DEVICE SETTING MANAGEMENT SYSTEM, DEVICE SETTING MANAGEMENT METHOD AND COMPUTER-READABLE RECORDING MEDIUM FOR DEVICE SETTING MANAGEMENT

(76) Inventors: Yumiko NOGUCHI, Kanagawa (JP); Tsugumi Harata, Kanagawa (JP); Haruko Shioda, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/719,165

(22) Filed: Mar. 8, 2010

(30) Foreign Application Priority Data
Mar. 17, 2009 (JP) 2009-064977

(51) Int. Cl. G06F 15/177; G06F 17/30

(52) U.S. Cl. 709/220; 707/802; 707/E17.044

(57) ABSTRACT

Provided are a device setting management system, a device setting management method, and a recording medium for device setting management, which efficiently change the setting of a device. A control unit of a device management system specifies a newly connected device which is not specified in mode setting management data as a target device. The control unit determines the sequential processing order of the specified target device, and sequentially transmits information on a setting change request to the device according to the determined sequential processing order. Upon reception of information on a setting change result including a device identifier of a device whose setting has been changed, the control unit stores a “mode-ON flag” and a “mode-OFF flag” in the mode setting management data including this device identifier to update a setting management flag.

### CROSS REFERENCES TO RELATED APPLICATION

This application claims the benefit of Japanese Patent Application No. 2009-64977 filed on Mar. 17, 2009, the entire disclosure of which is incorporated by reference herein.

### FIELD

The present invention relates to a device setting management system, a device setting management method, and a recording medium for device setting management for managing the setting of a device connected over a communication network.

### BACKGROUND OF THE INVENTION

At present, there are devices with a communication capability to carry out communication over the Internet or the like. For such devices, studies have been made on an art of remotely changing the setting of a device using the communication capability. For example, an image processing apparatus in which when a user terminal transmits a setting change request over a network, the setting management module of a device determines whether or not the setting can be changed, and changes the setting when the setting change is possible is proposed in Unexamined Japanese Patent Application KOKAI Publication No. 2007-214853.

Such changing of the setting of a device is carried out when the device is installed. This is because at the time of shipping a device to be newly connected, factory set values or the like are set as set values for the device. In addition, the setting of a device may be changed when desired by the user even after installment of the device.

When the number of target devices whose settings are to be changed becomes large, the load on a system which manages changing of the settings of devices increases. Further, the setting of a device cannot be changed unless the device is powered on. Therefore, the system needs to predict the power-ON state of a device and execute a process of changing the setting of the device. Furthermore, in case where devices are shipped worldwide, the system needs to manage changing of the settings of devices in consideration of time lags of individual areas.

### SUMMARY

Accordingly, it is an object of the present invention to provide a device setting management system, a device setting management method, and a computer-readable recording medium for device setting management, which efficiently change the setting of a device.

To achieve the object, a device setting management system according to one aspect of the invention includes:

a device management data storage unit that stores device management data including a device identifier specifying a device connected over a communication network, and a time-zone identifier specifying a time zone to which the device belongs;

a setting management data storage unit that stores a setting management data including a setting management flag indicating a setting state of a device and setting management data including the device identifier;

a new registration unit that specifies a device identifier of a device newly connected to the communication network based on the device identifier in the device management data stored in the device management data storage unit and the device identifier in the device management data stored in the setting management data storage unit, and registers setting management data including the specified device identifier and the setting state of the setting management flag in the setting management data storage unit;

a target device specifying unit that specifies a device whose setting is to be changed based on the device identifier of the device management data stored in the device management data storage unit and including a time-zone identifier of a time zone in which a current time has become a management detection time, and the device identifier in the setting management data which is stored in the setting management data storage unit and whose setting state is the setting state registered in the new registration unit;

a setting request transmitting unit that determines a sequential processing order of a device whose device identifier is specified by the target device specifying unit, and sequentially transmits information on a setting change request to the device according to the determined sequential processing order; and

an update unit that, upon reception of information on a setting change result indicating completion of a change in a setting of a device according to the information on the setting change request transmitted from the setting request transmitting unit, updates a setting management flag in setting management data including the received device identifier of the device.

The device setting management system may further include:

a management detection time storage unit that stores a management detection time of a time zone specified by the time-zone identifier;

a number-of-times data storage unit that stores number-of-times data including a number of times information on a setting change result including a device identifier of a device whose setting has not been changed despite transmission of information on the setting change request has been received, and the device identifier of the device;

a time-change threshold value storage unit that stores a time-change threshold value for changing the management detection time;

a time-computation value storage unit that stores a time-computation value for computing a changed management detection time;

a number-of-times storage unit that, upon reception of the information on the setting change result including the device identifier of the device whose setting has not been changed despite transmission of the information on the setting change request, searches for number-of-times data including the device identifier, stores number-of-times data including the device identifier and having “1” as a number of times in the number-of-times data storage unit when the number-of-times data including the device identifier is not stored, and increments the number of times in the number-of-times data of the device identifier by 1 and stores resultant number-of-times data in the number-of-times data storage unit when the number-of-times data including the device identifier is stored; and

a management detection time changing unit that, when the number of times in the number-of-times data stored in the number-of-times storage unit becomes equal to or greater than the time-change threshold value, acquires a time-zone identifier corresponding to the device identifier in the number-of-times data from the device management data storage unit, specifies a management detection time of a time zone specified by the acquired time-zone identifier from the management detection time storage unit, computes a new management detection time based on the specified management detection time and the time-computation value, and stores the computed management detection time in the management detection time storage unit.

The setting management flag may include a current-state flag indicating a current setting state and a changed-state flag indicating if the setting has been changed in the past. In this case, the target device specifying unit specifies a device with a device identifier with which a current-state flag indicating that the setting is not a preset setting is stored and a changed-state flag indicating that the setting has not been done is associated.

The device setting management system may further include a transmission interval storage unit that stores a transmission interval for transmitting information on the setting change request. In this case, in case of transmitting information on a setting change request to a device, the setting request transmitting unit specifies a transmission interval from transmission of the information on the setting change request transmitted to the device just previously, and transmits information on a setting change to the device upon elapse of a time equal to or greater than the transmission interval when the specified transmission interval is not equal to or greater than the transmission interval stored in the transmission interval storage unit.

The device setting management system may further include a communication terminal capable of updating the setting management flag in the setting management data stored in the setting management data storage unit.

A device setting management method according to a second aspect of the invention includes:

a device management data storage step of storing device management data including a device identifier specifying a device connected over a communication network, and a time-zone identifier specifying a time zone to which the device belongs;

a setting management data storage step of storing a setting management data including a setting management flag indicating a setting state of a device and the device identifier;

a new registration step of specifying a device identifier of a device newly connected to the communication network based on the device identifier in the device management data stored in the device management data storage step and the device identifier in the device management data stored in the setting management data storage step, and registering setting management data including the specified device identifier and the setting state of the setting management flag;

a target device specifying step of specifying a device whose setting is to be changed based on the device identifier of the device management data and including a time-zone identifier of a time zone in which a current time has become a management detection time, and the device identifier in the setting management data whose setting state is the setting state registered in the new registration step;

a setting request transmitting step of determining a sequential processing order of a device whose device identifier is specified in the target device specifying step, and sequentially transmitting information on a setting change request to the device according to the determined sequential processing order; and

an update step that, upon reception of information on a setting change result indicating completion of a change in a setting of a device according to the information on the setting change request transmitted in the setting request transmitting step, updating a setting management flag in setting management data including the received device identifier of the device.

The device setting management method may further include:

a management detection time storage step of storing a management detection time of a time zone specified by the time-zone identifier;

a number-of-times data storage step of storing number-of-times data including a number of times information on a setting change result including a device identifier of a device whose setting has not been changed despite transmission of information on the setting change request has been received, and the device identifier of the device;

a time-change threshold value storage step of storing a time-change threshold value for changing the management detection time;

a time-computation value storage step of storing a time-computation value for computing a changed management detection time;

a number-of-times storage step of, upon reception of the information on the setting change result including the device identifier of the device whose setting has not been changed despite transmission of the information on the setting change request, searching for number-of-times data including the device identifier, storing number-of-times data including the device identifier and having “1” as a number of times when the number-of-times data including the device identifier is not stored, and incrementing the number of times in the number-of-times data of the device identifier by 1 and storing resultant number-of-times data when the number-of-times data including the device identifier is stored; and

a management detection time changing step, when the number of times in the number-of-times data stored in the number-of-times storage step becomes equal to or greater than the time-change threshold value, acquiring a time-zone identifier corresponding to the device identifier in the number-of-times data from the device management data storage step, specifying a management detection time of a time zone specified by the acquired time-zone identifier from the management detection time storage step, computing a new management detection time based on the specified management detection time and the time-computation value, and storing the computed management detection time.

The setting management flag may include a current-state flag indicating a current setting state and a changed-state flag indicating if the setting has been changed in the past. In this case, the target device specifying step in which a device with a device identifier with which a current-state flag indicating that the setting is not a preset setting is stored and a changed-state flag indicating that the setting has not been done is associated is specified.

A transmission interval for transmitting information on the setting change request may be stored. In this case, in the setting request transmitting step, in case of transmitting information on a setting change request to a device, a transmission interval from transmission of the information on the setting change request transmitted to the device just previously is specified, and information on a setting change to the device is transmitted upon elapse of a time equal to or greater than the transmission interval when the specified transmission interval is not equal to or greater than the stored transmission interval.

According to a third aspect of the invention, there is provided a computer-readable recording medium for device setting management, recording a program for allowing a computer to function as:

a device management data storage unit that stores device management data including a device identifier specifying a device connected over a communication network, and a time-zone identifier specifying a time zone to which the device belongs;

a setting management data storage unit that stores a setting management data including a setting management flag indicating a setting state of a device and setting management data including the device identifier;

a new registration unit that specifies a device identifier of a device newly connected to the communication network based on the device identifier in the device management data stored in the device management data storage unit and the device identifier in the device management data stored in the setting management data storage unit, and registers setting management data including the specified device identifier and the setting state of the setting management flag in the setting management data storage unit;

a target device specifying unit that specifies a device whose setting is to be changed based on the device identifier of the device management data stored in the device management data storage unit and including a time-zone identifier of a time zone in which a current time has become a management detection time, and the device identifier in the setting management data which is stored in the setting management data storage unit and whose setting state is the setting state registered in the new registration unit;

a setting request transmitting unit that determines a sequential processing order of a device whose device identifier is specified by the target device specifying unit, and sequentially transmits information on a setting change request to the device according to the determined sequential processing order; and

an update unit that, upon reception of information on a setting change result indicating completion of a change in a setting of a device according to the information on the setting change request transmitted from the setting request transmitting unit, updates a setting management flag in setting management data including the received device identifier of the device.

The program may further allow the computer to function as:

a management detection time storage unit that stores a management detection time of a time zone specified by the time-zone identifier;

a number-of-times data storage unit that stores number-of-times data including a number of times information on a setting change result including a device identifier of a device whose setting has not been changed despite transmission of information on the setting change request has been received, and the device identifier of the device;

a time-change threshold value storage unit that stores a time-change threshold value for changing the management detection time;

a time-computation value storage unit that stores a time-computation value for computing a changed management detection time;

a number-of-times storage unit that, upon reception of the information on the setting change result including the device identifier of the device whose setting has not been changed despite transmission of the information on the setting change request, searches for number-of-times data including the device identifier, stores number-of-times data including the device identifier and having “1” as a number of times in the number-of-times data storage unit when the number-of-times data including the device identifier is not stored, and increments the number of times in the number-of-times data of the device identifier by 1 and stores resultant number-of-times data in the number-of-times data storage unit when the number-of-times data including the device identifier is stored; and

a management detection time changing unit that, when the number of times in the number-of-times data stored in the number-of-times storage unit becomes equal to or greater than the time-change threshold value, acquires a time-zone identifier corresponding to the device identifier in the number-of-times data from the device management data storage unit, specifies a management detection time of a time zone specified by the acquired time-zone identifier from the management detection time storage unit, computes a new management detection time based on the specified management detection time and the time-computation value, and stores the computed management detection time in the management detection time storage unit.

The setting management flag includes a current-state flag indicating a current setting state and a changed-state flag indicating if the setting has been changed in the past, and the target device specifying unit specifies a device with a device identifier with which a current-state flag indicating that the setting is not a preset setting is stored and a changed-state flag indicating that the setting has not been done is associated.

The program may further allow the computer to function as a transmission interval storage unit that stores a transmission interval for transmitting information on the setting change request. In this case, in case of transmitting information on a setting change request to a device, the setting request transmitting unit specifies a transmission interval from transmission of the information on the setting change request transmitted to the device just previously, and transmits information on a setting change to the device upon elapse of a time equal to or greater than the transmission interval when the specified transmission interval is not equal to or greater than the transmission interval stored in the transmission interval storage unit.

### BRIEF DESCRIPTION OF THE DRAWINGS

A more complete understanding of this application can be obtained when the following detailed description is considered in conjunction with the following drawings, in which:

FIG. 1 is a schematic configurational diagram of a system according to an embodiment of the invention;

FIG. 2A is a diagram showing a data structure stored in a device management data storage unit;

FIG. 2B is a diagram showing a data structure stored in a mode setting management data storage unit;

FIG. 3 is a flowchart illustrating a new device registration process; and

FIG. 4 is a flowchart illustrating a device setting management process.

### DETAILED DESCRIPTION

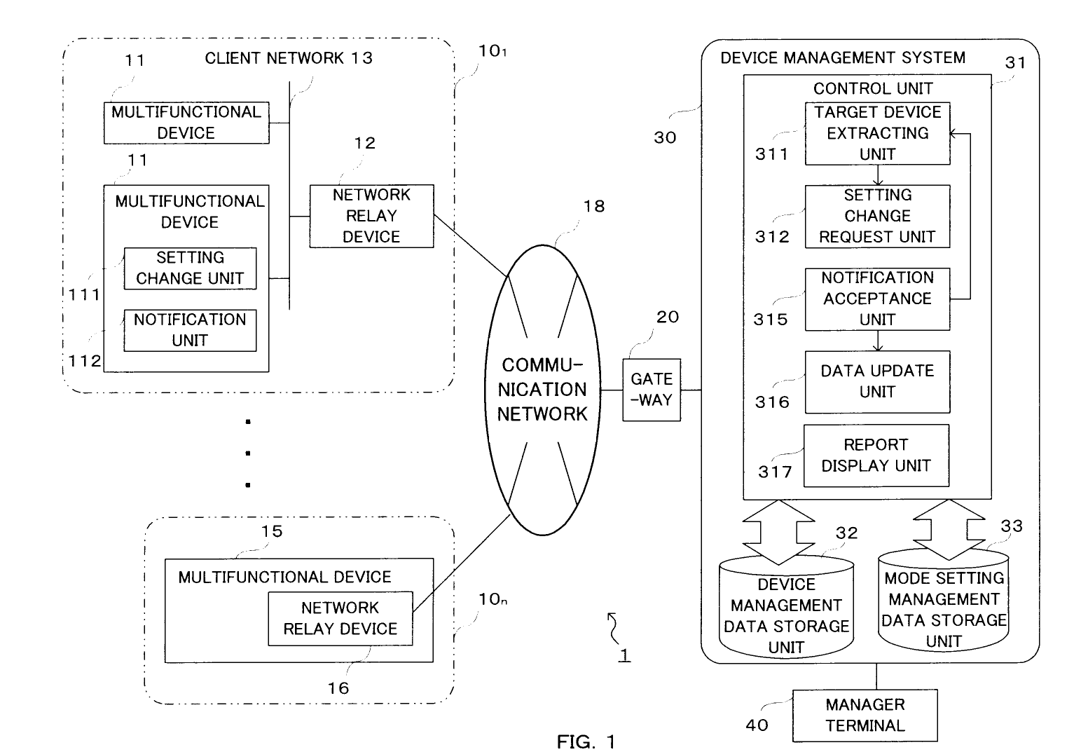

A device setting management system, a device setting management method, and a computer-readable recording medium for device setting management according to the present invention will be described below with reference to FIGS. 1 to 4. FIG. 1 is a schematic configurational diagram of a system according to the embodiment.

The embodiment of the invention will be described by way of example where a device management system 30 as a device setting management system manages functional settings of multifunctional devices 11, 15 sited at individual areas in the world. The description of the embodiment of the invention will be given of an example where as changing of the setting of a device, the notification mode of the multifunctional device 11, 15 is set “ON”, and a function of notifying “out of toner” of the multifunctional device 11, 15 is set.

As shown in FIG. 1, the present system 1 according to the embodiment includes clients 10 (10₁ to 10ₙ), a communication network 18, a gateway 20, and a device management system 30.

The clients 10 (10₁ to 10ₙ) are connected to the device management system 30 (gateway 20) over the communication network 18. The client 10 has a multifunctional device 11, 15, and a network relay device 12, 16. In the embodiment, the multifunctional device 11 of the client 10₁ is connected to the communication network 18 via the network relay device 12 connected to a client network 13. The multifunctional device 15 of the client 10ₙ incorporates the network relay device 16. The multifunctional device 15 is connected to the communication network 18 via the network relay device 16.

The multifunctional device 11, 15 has a copy function, a print function and a facsimile function. Further, the multifunctional device 11, 15 has a communication function to transmit/receive data over a network or the Internet. This communication function allows the multifunctional device 11, 15 to receive information on a setting change request from the device management system 30 (gateway 20), and transmit information on a setting change result to the device management system 30.

The multifunctional device 11, 15 has a setting change unit 111, and a notification unit 112. According to the embodiment, the setting change unit 111 and the notification unit 112 are operated when the power supply of the multifunctional device 11, 15 is “ON”.

The setting change unit 111 changes the settings of individual functions according to the setting change request from the device management system 30. In the embodiment, upon reception of information on a setting change request to set the notification mode “ON”, the setting change unit 111 executes a setting change according to the received information on the setting change request, i.e., sets the notification mode “ON”. When the setting change is completed, the setting change unit 111 returns information on a setting change result indicating completion of the setting change to the device management system 30.

When detecting that the multifunctional device 11, 15 matches with a condition relating to the notification mode whose setting has been changed by the setting change unit 111, the notification unit 112 notifies the device management system 30 of information (message) indicating that the multifunctional device 11, 15 matches with the condition. Specifically, when detecting that the notification mode is set “ON” and the remainder of the toner to be used for copying or printing is “0”, the notification unit 112 notifies the device management system 30 of a message “out of toner”.

The network relay device 12, 16 transmits/receives data to/from the gateway 20 (device management system 30) over the communication network 18.

The network relay device 12 acquires information on a setting change request for each multifunctional device 11 connected to the client network 13 from the gateway 20. The network relay device 12 transmits information on a setting change result from the multifunctional device 11 to the device management system 30 over the communication network 18. Further, the network relay device 12 regularly transmits a connected device notification including the device identifier of the multifunctional device 11 connected to the client network 13 to the device management system 30 (gateway 20).

In the embodiment, when detecting that a new multifunctional device 11 is connected to the client network 13, the network relay device 12 includes information to acquire information on a setting change request (information on an acquisition request) from the device management system 30 into a connected device notification, and transmits it to the gateway 20. The gateway 20 transmits the information on the setting change request to the network relay device 12 according to the information on the acquisition request from the network relay device 12. As a result, the network relay device 12 acquires the information on the setting change request from the gateway 20.

The network relay device 12 stores data on a client identifier and a time-zone identifier. The client identifier specifies a client who manages the client network 13 to which the network relay device 12 is connected. The time-zone identifier specifies the time zone of an area where the network relay device 12 is sited. The network relay device 12 transmits the client identifier and the time-zone identifier, together with the device identifier, to the device management system 30.

Further, the network relay device 12 monitors the ON/OFF state of the power supply of the multifunctional device 11 connected to the client network 13. When detecting that the multifunctional device 11 with the device identifier included in the information on the setting change request is in an “ON” state, the network relay device 12 transfers the information on the setting change request to the multifunctional device 11. When the multifunctional device 11 with the device identifier included in the information on the setting change request is in an “OFF” state, the network relay device 12 transmits information on a setting change request indicating that the setting of the multifunctional device 11 cannot be changed to the device management system 30.

The network relay device 16 stores the device identifier, client identifier and time-zone identifier of the multifunctional device 15. The network relay device 16, when connected to the communication network 18, transmits information on the connected device notification to the device management system 30. The connected device notification includes data on the device identifier, client identifier and time-zone identifier of the multifunctional device 15, and information on the acquisition request.

When the multifunctional device 15 with the device identifier included in the information on the setting change request is in an “ON” state, the network relay device 16 transfers the information on the setting change request from the device management system 30 to the multifunctional device 15. When the multifunctional device 15 with the device identifier included in the information on the setting change request is in an “OFF” state, on the other hand, the network relay device 16 transmits information on a setting change request indicating that the setting of the multifunctional device 15 cannot be changed to the device management system 30.

The communication network 18 is, for example, a communication network like the Internet, LAN (Local Area Network) or WAN (Wide Area Network) based on a predetermined communication protocol, such as TCP/IP (Transmission Control Protocol/Internet Protocol).

The gateway 20 is provided between the device management system 30 and the communication network 18. The gateway 20 stores information on a setting change request from the device management system 30. In response to the acquisition request from the network relay device 12, 16, the gateway 20 transmits information on a setting change request for the multifunctional device 11 connected with the network relay device 12, or the multifunctional device 15 incorporating the network relay device 16 to the network relay device 12, 16.

In the embodiment, a predetermined time (time-out time) prescribed beforehand is stored in the gateway 20. Upon reception of information on an acquisition request from the network relay device 12, 16 connected to a device whose device identifier is included in the setting change request within the time-out time, the gateway 20 transmits information on a setting change request to the multifunctional device 11, 15. When information on an acquisition request from the network relay device 12, 16 is not received within the time-out time, on the other hand, the gateway 20 discards the information on the setting change request. Then, the gateway 20 transmits information on a setting change request indicating that the setting cannot be changed to the device management system 30.

The device management system 30 manages the settings of the multifunctional devices 11, 15. The device management system 30 includes a control unit 31, a device management data storage unit 32, and a mode setting management data storage unit 33. In the embodiment, the control unit 31 serves as control means. The device management data storage unit 32 serves as device management storage means. The mode setting management data storage unit 33 serves as setting management storage means.

The control unit 31 includes a CPU (Central Processing Unit), memories, such as RAM (Random Access Memory) and ROM (Read Only Memory), and a clock. Further, the control unit 31 stores a time lag of a time zone with respect to the time specified by the built-in clock in association with the time-zone identifier.

The control unit 31 executes a new device registration process to be described later to store information on device management data of a newly connected multifunctional device 11, 15 in the device management data storage unit 32, and store information on mode setting management data of the newly connected multifunctional device 11, 15 in the mode setting management data storage unit 33.

In addition, the control unit 31 executes a device setting management process to be described later to function as a target device extracting unit 311, a setting change request unit 312, a notification acceptance unit 315, a data update unit 316, a report display unit 317, etc.

The target device extracting unit 311 extracts a target device which transmits information on a setting change request. In the embodiment, the target device extracting unit 311 stores data on a management detection time, and extracts a device whose notification mode is not OFF at the management detection time and whose setting has not been changed in the past, as a target device. The management detection time is set to the same time (the same local time) regardless of areas. A time (e.g., 13 o'clock) by which it is likely that the multifunctional device 11, 15 is powered “ON” to be used is used as the management detection time.

The setting change request unit 312 transmits information on a setting change request to the target device extracted by the target device extracting unit 311. In the embodiment, the setting change request unit 312 specifies target devices one at a time, and sequentially transmits information on a setting change request to the target devices in the specified sequential processing order.

The notification acceptance unit 315 executes a process of receiving information on a setting change result which is a reply to the information on the setting change request.

The data update unit 316 executes a process of updating data in the mode setting management data storage unit 33 according to the setting change result.

The report display unit 317 executes a process of displaying data or the like in the mode setting management data storage unit 33 of each device (multifunctional device 11, 15) on a manager terminal 40 to be described later.

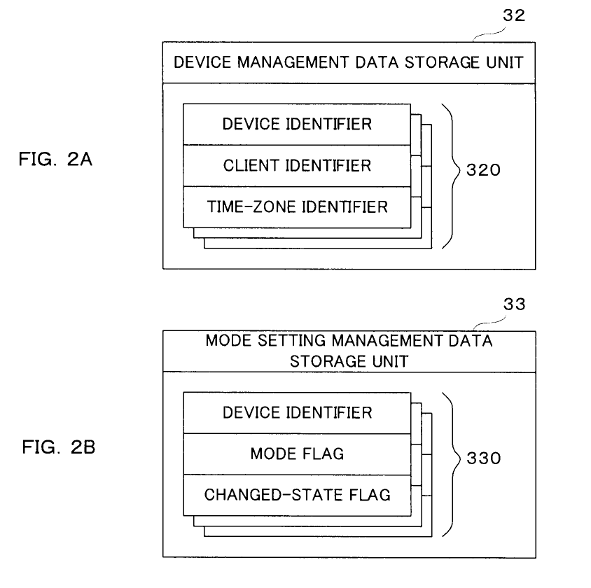

For example, information on device management data 320 for device management, such as a device identifier, a client identifier, and a time-zone identifier, as shown in FIG. 2A is stored in the device management data storage unit 32. The device management data 320 is stored in the device management data storage unit 32 as the control unit 31 executes the new device registration process to be described later.

Data on an identifier (device identifier) for specifying a device to be managed (multifunctional device 11, 15) is stored in a device identifier data area.

Data on an identifier (client identifier) for specifying a client who uses this device is stored in a client identifier data area.

Data on an identifier (time-zone identifier) for specifying a time zone of an area where this device is sited (area where the network relay device 12 is sited in case of the multifunctional device 11) is stored in a time-zone identifier data area.

As shown in FIG. 2B, information on mode setting management data 330 for managing changing of device settings, such as a device identifier, mode flag and change-state flag is stored in the mode setting management data storage unit 33. The mode setting management data 330 is stored in the mode setting management data storage unit 33 as the control unit 31 executes the device setting management process to be described later.

Data on an identifier (device identifier) for specifying a device to be managed (multifunctional device 11, 15) is stored in a device identifier data area.

A flag indicating if the notification mode of this device is ON or OFF (mode flag) is stored in a mode flag data area. This mode flag functions as a current-state flag indicating the current setting state. In the embodiment, when new registration to be described later is carried out, a flag indicating that the notification mode is OFF (mode-OFF flag) is stored in the mode flag data area. Upon reception of information on a setting change result indicating that the setting change has been completed in response to the setting change request, a flag indicating that the notification mode is ON (mode-ON flag) is stored in the mode flag data area.

A changed-state flag indicating whether or not a setting change to set the mode ON of the device has been done in the past is stored in a change-state flag data area. In the embodiment, when new registration is carried out, a flag indicating that the setting has not been changed (no-change flag) is stored in the change-state flag data area. Upon reception of information on a setting change result indicating that the setting change has been completed in response to the setting change request, the no-change flag is erased and a flag indicating that the setting has been changed (change-done flag) is stored in the change-state flag data area.

As shown in FIG. 1, the manager terminal 40 is connected to the device management system 30. The manager terminal 40 includes a display unit (not shown) having a display, and an operation unit (not shown) having a keyboard and a pointing device. The display unit displays information on each multifunctional device 11, 15 and a mode set state thereof. The manager of the present system 1 can perform new registration, erasure and change on data in the device management data 320 and the mode setting management data 330 by operating the operation unit of the manager terminal 40.

For example, when the manager of the present system 1 grasps a device whose notification mode is set “OFF” for its usage, the manager operates the manager terminal 40 to store the “mode-OFF flag” in the mode flag data area in the mode setting management data 330 and store the “change-done flag” in the change-state data area therein. In this case, as will be described later, the control unit 31 does not extract a device whose “change-done flag” is stored as a target device, making it possible not to change the setting of this device. In addition, the control unit 31 of the device management system 30 does not transmit information on an unnecessary setting change request, making it possible to reduce the load on the device management system 30.

Next, a description will be given of a device setting management method using the system 1 with the foregoing configuration. The new device registration process, and the device setting management process will be discussed in the named order.

### (New Device Registration Process)

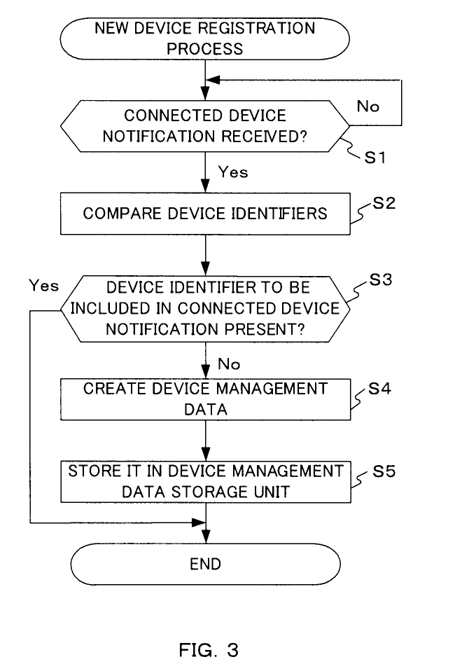

In the new device registration process, with regard to a multifunctional device 11, 15 newly connected to the device management system 30, information on device management data is stored in the device management data storage unit 32, and information on mode setting management data is stored in the mode setting management data storage unit 33. FIG. 3 is a flowchart illustrating the new device registration process. The new device registration process will be described below referring to FIG. 3.

It is to be noted that as mentioned above, the network relay device 12, 16 regularly acquires the device identifier of the multifunctional device 11, 15 connected to the client network 13 and the communication network 18. Then, the network relay device 12, 16 transmits a connected device notification including data on the acquired device identifier, a client identifier and a time-zone identifier to the device management system 30. When a new multifunctional device 11, 15 is connected to the client network 13 or the like, the network relay device 12, 16 includes data on the device identifier of the newly connected multifunctional device 11, 15 in the connected device notification.

First, the control unit 31 of the device management system 30 discriminates whether or not the connected device notification from the network relay device 12, 16 is received (step S1). When it is discriminated that the connected device notification is received (step S1: Yes), the control unit 31 compares the device identifier, client identifier and time-zone identifier included in the received connected device notification with the device management data 320 (device identifier, client identifier and time-zone identifier) stored in the device management data storage unit 32, respectively (step S2).

Next, the control unit 31 discriminates whether or not the device management data 320 stored in the device management data storage unit 32 contains the device identifier included in the connected device notification (step S3). When it is discriminated that the device management data 320 contains the device identifier included in the connected device notification (step S3: Yes), the control unit 31 terminates this process.

When it is discriminated that the device management data 320 does not contain the device identifier included in the connected device notification (step S3: No), the control unit 31 generates device management data 320 including the discriminated device identifier and the client identifier and time-zone identifier which are associated therewith (step S4). Then, the control unit 31 stores the generated device management data 320 in the device management data storage unit 32 (step S5), and terminates the process.

### (Device Setting Management Process)

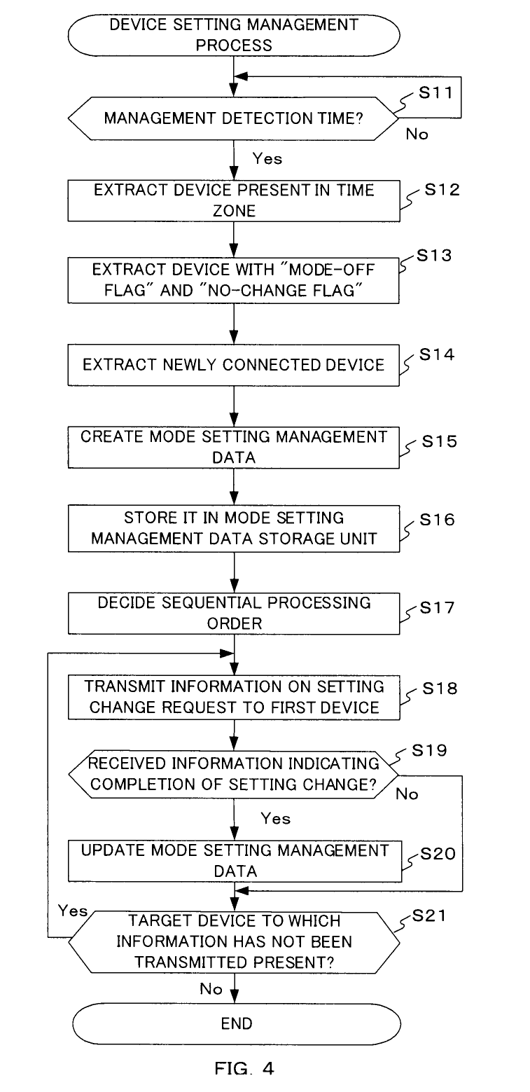

Next, the device setting management process will be described referring to FIG. 4. FIG. 4 is a flowchart illustrating the device setting management process. The description will be given of a case where the device management system 30 executes the device setting management process every one hour based on the time specified by the built-in clock in the embodiment by way of example.

First, the control unit 31 of the device management system 30 discriminates whether or not the time specified by the built-in clock has become the management detection time (step S11). When it is discriminated that the time specified by the built-in clock has become the management detection time (step S11: Yes), the control unit 31 extracts devices which are present in the time zone where the local time has become the management detection time (step S12). Specifically, the target device extracting unit 311 of the control unit 31 acquires the current time from the built-in clock, and specifies the time-zone identifier of the time zone where the local time has become the management detection time from the time lag obtained from the current time and the time-zone identifier. The target device extracting unit 311 extracts the device management data 320 including the specified time-zone identifier from the device management data storage unit 32.

Next, the control unit 31 extracts, from the extracted devices, a device whose mode flag data has the “mode-OFF flag” and whose changed-state flag data has the “no-change flag” (step S13). That is, the control unit 31 extracts, from the extracted devices, any device whose information is merely stored in the device management data storage unit 32 and whose setting has not been changed yet (device having the initial setting). Specifically, the target device extracting unit 311 of the control unit 31 extracts those pieces of mode setting management data 330 which include the device identifier in the device management data 320 extracted in step S12 from the mode setting management data storage unit 33. Next, the target device extracting unit 311 extracts, from the extracted mode setting management data 330, any mode setting management data 330 which has the “mode-OFF flag” stored in the mode flag data area and the “no-change flag” stored in the changed-state flag data area. Then, the target device extracting unit 311 specifies devices with the device identifiers in those extracted pieces of mode setting management data 330, as target devices.

It is to be noted that the target device extracting unit 311 extracts mode setting management data 330 which the “mode-OFF flag” stored in the mode flag data area thereof and has the “no-change flag” stored in the changed-state flag data area thereof. As the manager of the present system 1 stores the “change-done flag” in the changed-state flag data area this way, it is possible not to change the setting of the device.

Subsequently, the control unit 31 extracts a device newly connected (step S14). Specifically, the target device extracting unit 311 of the control unit 31 compares the device identifiers in those pieces of device management data 320 which include the time-zone identifier of the time zone where the local time has become the management detection time, with the device identifier in the mode setting management data 330. Then, the target device extracting unit 311 specifies a device with the device identifier in the device management data 320 which is not included in the mode setting management data 330, as a target device.

Next, the control unit 31 creates mode setting management data 330 for the newly connected device in step S14 (device specified as the target device) (step S15). Then, the control unit 31 stores the generated mode setting management data 330 in the mode setting management data storage unit 33 (step S16). In this case, the control unit 31 stores the “mode-OFF flag” indicating that the notification mode of the device is “OFF” in the mode flag data area in the mode setting management data 330. The control unit 31 also stores the “no-change flag” indicating that a setting change to set the mode of the device “ON” has not been made in the changed-state flag data area.

Subsequently, the control unit 31 decides the sequential processing order of the specified target devices (step S17). The control unit 31 decides the sequential processing order of the target devices based on, for example, the alphabets, numerals or the like of the device identifiers.

Next, the control unit 31 transmits information on a setting change request to the first target device decided (step S18). Specifically, the setting change request unit 312 of the control unit 31 transmits information on a setting change request to set the mode setting “ON” to the first target device decided. This setting change request includes the specified device identifier.

The information on the setting change request transmitted by the device management system 30 is stored in the gateway 20. When there is an acquisition request from the network relay device 12, 16 within the time-out time, the gateway 20 transmits information on the setting change request to the network relay device 12, 16. The network relay device 12, 16 receives the information on the setting change request.

When the power of the multifunctional device 11 with the device identifier included in the received information on the setting change request is “ON”, the network relay device 12 transmits the information on the setting change request to the multifunctional device 11. The multifunctional device 11 receives this information on the setting change request. The multifunctional device 11 (setting change unit 111) changes the setting to set the notification mode “ON” in response to the setting change request. When the setting change is completed, the multifunctional device 11 (notification unit 112) transmits information on a setting change result indicating the completion of the setting change to the device management system 30 via the network relay device 12. In this case, the setting change result includes the device identifier of the multifunctional device 11 whose setting has been changed.

When the power of the multifunctional device 11 with the device identifier included in the received information on the setting change request is “OFF”, on the other hand, the network relay device 12 transmits information on a setting change result indicating that the setting could not be changed to the device management system 30. It is to be noted that the setting change result includes the device identifier of the multifunctional device 11 whose setting could not be changed.

When the power is “ON”, the multifunctional device 15 changes the setting to set the notification mode “ON” according to the information on the setting change request acquired by the network relay device 16. When the setting change is completed, the multifunctional device 15 transmits information on a setting change result indicating the completion of the setting change to the device management system 30 via the network relay device 16. In this case, the information on the setting change result includes data on the device identifier of the multifunctional device 15 whose setting has been changed.

When the power of the multifunctional device 15 is “OFF”, on the other hand, the network relay device 16 transmits information on a setting change result indicating that the setting could not be changed to the device management system 30. It is to be noted that the setting change result includes data on the device identifier of the multifunctional device 15 whose setting could not be changed.

When the gateway 20 does not receive information on an acquisition request from the network relay device 12, 16 within the time-out time, the gateway 20 discharges the information on the setting change request from the device management system 30, and transmits information on a setting change result indicating that the setting could not be changed to the device management system 30.

The control unit 31 receives information on a setting change result in the above manner.

Next, the control unit 31 discriminates whether or not the received information on the setting change result is setting change result information indicating the completion of the setting change (step S19). When it is discriminated that the received information is setting change result information indicating the completion of the setting change (step S19: Yes), the control unit 31 updates the mode setting management data 330 of the target device (step S20). Specifically, the data update unit 316 of the control unit 31 extracts mode setting management data 330 including the device identifier included in the setting change result information indicating the completion of the setting change. The data update unit 316 stores (changes) the “mode-ON flag” in the mode flag data area in the mode setting management data 330. Further, the data update unit 316 stores (changes) the “change-done flag” in the changed-state flag data in the mode setting management data 330.

When it is discriminated that the received information is not setting change result information indicating the completion of the setting change, i.e., setting change result information indicating that the setting of the device could not be changed from the network relay device 12, 16 is received (step S19: No), the control unit 31 proceeds to step S21.

Subsequently, the control unit 31 discriminates whether or not there is another target device to which information on a setting change request has not been transmitted (step S21). When it is discriminated that there is another target device to which information on a setting change request has not been transmitted (step S21: Yes), the control unit 31 returns to step S18 to repeatedly execute the processes of steps S18 to S20.

When it is discriminated that there is not any target device to which information on a setting change request has not been transmitted (step S21: No), the control unit 31 terminates this process. In this manner, the control unit 31 repeatedly executes the foregoing processes of steps S18 to S20 for each target device specified in steps S13 and S14.

According to the embodiment, the control unit 31 specifies only a newly connected device and a device whose information is merely stored in the device management data storage unit 32 and whose setting has not been changed yet. This makes it possible to automatically change the settings of devices which have the initial settings. Therefore, the settings of devices can be changed efficiently.

According to the embodiment, the control unit 31 decides the sequential processing order of specified target devices, and transmits information on a setting change request to the first target device decided. Even when there are multiple target devices whose settings should be changed, the control unit 31 transmits information on a setting change request for the multifunctional device 11, 15 in order. Accordingly, the processing load on the device management system 30 does not become large rapidly, and the settings of devices can be changed efficiently.

According to the embodiment, the control unit 31 executes the setting changes of devices for each time zone where the local time has become the management detection time. This can disperse the processing load on the device management system 30, thus ensuring efficient changing of the settings of devices.

According to the embodiment, the control unit 31 determines whether or not to transmit information on a setting change request based on the mode flag and the changed-state flag. That is, the control unit 31 extracts mode setting management data 330 which has the “mode-OFF flag” stored in the mode flag data area thereof, and has the “no-change flag” stored in the changed-state flag data area thereof. As the manager of the present system 1 stores the “change-done flag” in the changed-state flag data area this way, it is possible not to change the settings of devices. Further, the control unit 31 of the device management system 30 does not transmit information on an unnecessary setting change request, so that the load on the device management system 30 can be reduced.

Furthermore, even in case where information on a setting change request cannot be transmitted when a device is detected as a newly connected target device, or even in case where the setting of a target device could not been changed because the power of the target device is OFF, the control unit 31 transmits information on a setting change request again in the device setting management process at a next management detection time to ensure automatic changing of the setting of the device.

The invention can be modified and applied in various forms. The following describes other embodiments adaptable to the invention.

The control unit 31 (target device extracting unit 311) of the device management system 30 may have a number-of-times storage unit. The number-of-times storage unit stores number-of-times data including the number of times information on a setting change result including the device identifier of a device whose setting could not be changed despite transmission of information on the setting change request has been received, and the device identifier of the device. The number-of-times storage unit stores a time-change threshold value for changing the management detection time, and a time-computation value for computing a changed management detection time.

In such a device management system 30, upon reception of information on a setting change result including the device identifier of the device whose setting could not be changed, the control unit 31 searches in the number-of-times storage unit for number-of-times data including the device identifier. When the number-of-times data including the device identifier is not stored, the control unit 31 stores number-of-times data including the device identifier and having “1” as the number of transmissions in the number-of-times storage unit. When the number-of-times data including the device identifier is stored, the control unit 31 increments the number of transmissions in the number-of-times data of the device identifier by 1, and stores resultant number-of-times data in the number-of-times storage unit.

When the number of transmissions in the number-of-times data stored in the number-of-times storage unit becomes equal to or greater than the time-change threshold value, the control unit 31 changes the management detection time. Specifically, the control unit 31 acquires a time-zone identifier corresponding to the device identifier whose number of transmissions becomes equal to or greater than the time-change threshold value from the device management data storage unit 32, and specifies the management detection time of this time zone. The control unit 31 computes a new management detection time based on the specified management detection time and the time-computation value, and stores the computed management detection time in the target device extracting unit 311. With regard to a device whose setting change has failed multiple times, therefore, it is possible to automatically change the management detection time at which information on a setting change request is to be transmitted, and transmit information on a setting change request again. Because information on a setting change request can be transmitted at a time different from the time at which the setting could not be changed so far, the possibility of changing the setting of the device can be enhanced.

The setting change request unit 312 may have a transmission time storage unit to store data on the transmission time for information on a setting change request transmitted just previously. In this case, the setting change request unit 312 stores data on a transmission interval (e.g., two seconds) for transmitting information on a setting change request. When the transmission interval (e.g., two seconds) or longer has not elapsed since previous transmission of information on a setting change request, the setting change request unit 312 transmits information on a setting change to the target device when the transmission interval or longer elapses. Specifically, in case of transmitting information on a setting change request to a target device, the setting change request unit 312 checks if a time equal to or greater than the transmission interval has elapsed since the transmission time stored in the transmission time storage unit. When the time equal to or greater than the transmission interval has elapsed, the setting change request unit 312 immediately transmits information on a setting change request. When the time less than the transmission interval has elapsed, on the other hand, the setting change request unit 312 transmits information on a setting change request upon elapse of the time. This can disperse the processing load on the device management system 30, thus ensuring efficient changing of the settings of devices.

The foregoing of the embodiment of the invention has been given of the example where the same management detection time is used in individual time zones. The invention is not however limited to this case, and the management detection time may be changed time zone by time zone. When there are consecutive time zones where many target devices are present, for example, the management detection times of the individual time zones may be set in such a way that the world standard time for executing the device setting management process in one of such time zones, and the world standard time for executing the device setting management process in a time zone where there are a small number of target devices are changed over from one to the other.

When the previous device setting management process is not completed, a next device setting management process may be executed upon completion of the previous one. Specifically, when it is discriminated that the management detection time has arrived (step S11: Yes), the control unit 31 discriminates whether or not the previous device setting management process has been completed, and executes the sequence of processes starting at step S13 when the previous device setting management process is completed. Further, when a predetermined time, e.g., one hour, has elapsed since the initiation of the previous device setting management process, the control unit 31 may interrupt the device setting management process which is in progress, and start a new device setting management process.

The foregoing description of the embodiment of the invention has been given of the case where the control unit 31 transmits information on a setting change request to set the notification mode “ON” to every multifunctional device 11, 15 by way of example. However, the invention is not limited to this case, and the setting may be changed to the same setting for each client. Specifically, the target device extracting unit 311 of the control unit 31 specifies the client identifier in the device management data 320 including the device identifier specified in step S14. The target device extracting unit 311 specifies device identifiers in those pieces of device management data 320 which include this client identifier, extracts device management data 320 including those device identifiers, and acquires the mode flag and the changed-state flag. When the mode-OFF flag and the change-done flag are stored in every device management data 320, the target device extracting unit 311 stores mode setting management data 330 which includes the same flags (mode-OFF flag and change-done flag) as those stored flags. This makes it possible to automatically set the setting of a newly connected device to the same settings of other devices for clients whose notification modes are “OFF”.

The foregoing description of the embodiment of the invention has been given of the case where the control unit 31 decides the sequential processing order of specified target devices, and transmits information on a setting change request to the first target device decided by way of example. Instead, target devices may be extracted one by one. Specifically, the control unit 31 extracts target devices one by one in step S13, and executes steps S18 to S20. Then, after making a request to change the settings of devices which have the initial settings, the control unit 31 extracts newly connected target devices one by one, and executes steps S18 to S20. In this case, information on a setting change request can be transmitted, by priority, to a device with the device identifier previously stored in the mode setting management data 330 as a new device.

The foregoing description of the embodiment of the invention has been given of the case where the control unit 31 receives information on a setting change result, and then transmits information on a setting change request to another target device by way of example. Instead, the control unit 31 may sequentially transmit information on a setting change request to a next device regardless of whether or not to transmit information on a setting change result.

The foregoing description of the embodiment of the invention has been given of the case where the notification mode of a device is changed to “ON” by way of example. The setting change of a device is not limited to this type, and the setting to be changed may be anything as long as the setting can be changed according to a setting change request acquired by the device over a network.

The foregoing description of the embodiment of the invention has been given of the case where the setting of the multifunctional device 11, 15 is changed by way of example. A device whose setting is to be changed can be anything which has a communication function and whose setting can be changed in response to an external request, and may be, for example, a computer terminal.

The device management system 30 according to the embodiment is not limited to a dedicated system, and can be realized by using an ordinary computer system. For example, the device management system 30 that executes the above-described processes can be configured by installing programs for executing the above-described processes into a general-purpose computer from a recording medium (flexible disk, CD-ROM or the like) storing those programs.

The means for supplying those programs is optional. In addition to the supply of the programs from a predetermined recording medium as mentioned above, the programs may be supplied via, for example, a communication circuit, a communication network, a communication system or the like. In this case, for example, the programs may be posted on a bulletin board system (BBS) on a communication network, and may be provided in the form of being superimposed on carrier waves. The foregoing processes can be executed by invoking the programs provided in such a manner, and then executing the programs under control of the OS in the same way as other application programs.

Having described and illustrated the principles of this application by reference to one or more preferred embodiments, it should be apparent that the preferred embodiments may be modified in arrangement and detail without departing from the principles disclosed herein and that it is intended that the application be construed as including all such modifications and variations insofar as they come within the spirit and scope of the subject matter disclosed herein.

What is claimed is:

1. A device setting management system comprising:
a device management data storage unit that stores device management data including a device identifier specifying a device connected over a communication network, and a time-zone identifier specifying a time zone to which the device belongs;
a setting management data storage unit that stores a setting management data including a setting management flag indicating a setting state of a device and setting management data including the device identifier;
a new registration unit that specifies a device identifier of a device newly connected to the communication network based on the device identifier in the device management data stored in the device management data storage unit and the device identifier in the device management data stored in the setting management data storage unit, and registers setting management data including the specified device identifier and the setting state of the setting management flag in the setting management data storage unit;
a target device specifying unit that specifies a device whose setting is to be changed based on the device identifier of the device management data stored in the device management data storage unit and including a time-zone identifier of a time zone in which a current time has become a management detection time, and the device identifier in the setting management data which is stored in the setting management data storage unit and whose setting state is the setting state registered in the new registration unit;
a setting request transmitting unit that determines a sequential processing order of a device whose device identifier is specified by the target device specifying unit, and sequentially transmits information on a setting change request to the device according to the determined sequential processing order; and
an update unit that, upon reception of information on a setting change result indicating completion of a change in a setting of a device according to the information on the setting change request transmitted from the setting request transmitting unit, updates a setting management flag in setting management data including the received device identifier of the device.

2. The device setting management system according to claim 1, further comprising:
a management detection time storage unit that stores a management detection time of a time zone specified by the time-zone identifier;
a number-of-times data storage unit that stores number-of-times data including a number of times information on a setting change result including a device identifier of a device whose setting has not been changed despite transmission of information on the setting change request has been received, and the device identifier of the device;
a time-change threshold value storage unit that stores a time-change threshold value for changing the management detection time;
a time-computation value storage unit that stores a time-computation value for computing a changed management detection time;
a number-of-times storage unit that, upon reception of the information on the setting change result including the device identifier of the device whose setting has not been changed despite transmission of the information on the setting change request, searches for number-of-times data including the device identifier, stores number-of-times data including the device identifier and having “1” as a number of times in the number-of-times data storage unit when the number-of-times data including the device identifier is not stored, and increments the number of times in the number-of-times data of the device identifier by 1 and stores resultant number-of-times data in the number-of-times data storage unit when the number-of-times data including the device identifier is stored; and
a management detection time changing unit that, when the number of times in the number-of-times data stored in the number-of-times storage unit becomes equal to or greater than the time-change threshold value, acquires a time-zone identifier corresponding to the device identifier in the number-of-times data from the device management data storage unit, specifies a management detection time of a time zone specified by the acquired time-zone identifier from the management detection time storage unit, computes a new management detection time based on the specified management detection time and the time-computation value, and stores the computed management detection time in the management detection time storage unit.

3. The device setting management system according to claim 1, wherein the setting management flag includes a current-state flag indicating a current setting state and a changed-state flag indicating if the setting has been changed in the past, and
the target device specifying unit specifies a device with a device identifier with which a current-state flag indicating that the setting is not a preset setting is stored and a changed-state flag indicating that the setting has not been done is associated.

4. The device setting management system according to claim 1, further comprising a transmission interval storage unit that stores a transmission interval for transmitting information on the setting change request,
wherein in case of transmitting information on a setting change request to a device, the setting request transmitting unit specifies a transmission interval from transmission of the information on the setting change request transmitted to the device just previously, and transmits information on a setting change to the device upon elapse of a time equal to or greater than the transmission interval when the specified transmission interval is not equal to or greater than the transmission interval stored in the transmission interval storage unit.

5. The device setting management system according to claim 1, further comprising a communication terminal capable of updating the setting management flag in the setting management data stored in the setting management data storage unit.

6. A device setting management method comprising:
a device management data storage step of storing device management data including a device identifier specifying a device connected over a communication network, and a time-zone identifier specifying a time zone to which the device belongs;
a setting management data storage step of storing a setting management data including a setting management flag indicating a setting state of a device and the device identifier;
a new registration step of specifying a device identifier of a device newly connected to the communication network based on the device identifier in the device management data stored in the device management data storage step and the device identifier in the device management data stored in the setting management data storage step, and registering setting management data including the specified device identifier and the setting state of the setting management flag;
a target device specifying step of specifying a device whose setting is to be changed based on the device identifier of the device management data and including a time-zone identifier of a time zone in which a current time has become a management detection time, and the device identifier in the setting management data whose setting state is the setting state registered in the new registration step;
a setting request transmitting step of determining a sequential processing order of a device whose device identifier is specified in the target device specifying step, and sequentially transmitting information on a setting change request to the device according to the determined sequential processing order; and
an update step that, upon reception of information on a setting change result indicating completion of a change in a setting of a device according to the information on the setting change request transmitted in the setting request transmitting step, updating a setting management flag in setting management data including the received device identifier of the device.

7. The device setting management method according to claim 6, further comprising:
a management detection time storage step of storing a management detection time of a time zone specified by the time-zone identifier;
a number-of-times data storage step of storing number-of-times data including a number of times information on a setting change result including a device identifier of a device whose setting has not been changed despite transmission of information on the setting change request has been received, and the device identifier of the device;
a time-change threshold value storage step of storing a time-change threshold value for changing the management detection time;
a time-computation value storage step of storing a time-computation value for computing a changed management detection time;
a number-of-times storage step of, upon reception of the information on the setting change result including the device identifier of the device whose setting has not been changed despite transmission of the information on the setting change request, searching for number-of-times data including the device identifier, storing number-of-times data including the device identifier and having “1” as a number of times when the number-of-times data including the device identifier is not stored, and incrementing the number of times in the number-of-times data of the device identifier by 1 and storing resultant number-of-times data when the number-of-times data including the device identifier is stored; and
a management detection time changing step, when the number of times in the number-of-times data stored in the number-of-times storage step becomes equal to or greater than the time-change threshold value, acquiring a time-zone identifier corresponding to the device identifier in the number-of-times data from the device management data storage step, specifying a management detection time of a time zone specified by the acquired time-zone identifier from the management detection time storage step, computing a new management detection time based on the specified management detection time and the time-computation value, and storing the computed management detection time.

8. The device setting management method according to claim 6, wherein the setting management flag includes a current-state flag indicating a current setting state and a changed-state flag indicating if the setting has been changed in the past, and
the target device specifying step in which a device with a device identifier with which a current-state flag indicating that the setting is not a preset setting is stored and a changed-state flag indicating that the setting has not been done is associated is specified.

9. The device setting management method according to claim 6, wherein a transmission interval for transmitting information on the setting change request is stored, and
in the setting request transmitting step, in case of transmitting information on a setting change request to a device, a transmission interval from transmission of the information on the setting change request transmitted to the device just previously is specified, and information on a setting change to the device is transmitted upon elapse of a time equal to or greater than the transmission interval when the specified transmission interval is not equal to or greater than the stored transmission interval.

10. A computer-readable recording medium for device setting management, recording a program for allowing a computer to function as:
a device management data storage unit that stores device management data including a device identifier specifying a device connected over a communication network, and a time-zone identifier specifying a time zone to which the device belongs;
a setting management data storage unit that stores a setting management data including a setting management flag indicating a setting state of a device and setting management data including the device identifier;
a new registration unit that specifies a device identifier of a device newly connected to the communication network based on the device identifier in the device management data stored in the device management data storage unit and the device identifier in the device management data stored in the setting management data storage unit, and registers setting management data including the specified device identifier and the setting state of the setting management flag in the setting management data storage unit;
a target device specifying unit that specifies a device whose setting is to be changed based on the device identifier of the device management data stored in the device management data storage unit and including a time-zone identifier of a time zone in which a current time has become a management detection time, and the device identifier in the setting management data which is stored in the setting management data storage unit and whose setting state is the setting state registered in the new registration unit;
a setting request transmitting unit that determines a sequential processing order of a device whose device identifier is specified by the target device specifying unit, and sequentially transmits information on a setting change request to the device according to the determined sequential processing order; and
an update unit that, upon reception of information on a setting change result indicating completion of a change in a setting of a device according to the information on the setting change request transmitted from the setting request transmitting unit, updates a setting management flag in setting management data including the received device identifier of the device.

11. The computer-readable recording medium according to claim 10, wherein the program further allows the computer to function as:
a management detection time storage unit that stores a management detection time of a time zone specified by the time-zone identifier;
a number-of-times data storage unit that stores number-of-times data including a number of times information on a setting change result including a device identifier of a device whose setting has not been changed despite transmission of information on the setting change request has been received, and the device identifier of the device;
a time-change threshold value storage unit that stores a time-change threshold value for changing the management detection time;
a time-computation value storage unit that stores a time-computation value for computing a changed management detection time;
a number-of-times storage unit that, upon reception of the information on the setting change result including the device identifier of the device whose setting has not been changed despite transmission of the information on the setting change request, searches for number-of-times data including the device identifier, stores number-of-times data including the device identifier and having “1” as a number of times in the number-of-times data storage unit when the number-of-times data including the device identifier is not stored, and increments the number of times in the number-of-times data of the device identifier by 1 and stores resultant number-of-times data in the number-of-times data storage unit when the number-of-times data including the device identifier is stored; and
a management detection time changing unit that, when the number of times in the number-of-times data stored in the number-of-times storage unit becomes equal to or greater than the time-change threshold value, acquires a time-zone identifier corresponding to the device identifier in the number-of-times data from the device management data storage unit, specifies a management detection time of a time zone specified by the acquired time-zone identifier from the management detection time storage unit, computes a new management detection time based on the specified management detection time and the time-computation value, and stores the computed management detection time in the management detection time storage unit.

12. The computer-readable recording medium according to claim 10, wherein the setting management flag includes a current-state flag indicating a current setting state and a changed-state flag indicating if the setting has been changed in the past, and
the target device specifying unit specifies a device with a device identifier with which a current-state flag indicating that the setting is not a preset setting is stored and a changed-state flag indicating that the setting has not been done is associated.

13. The computer-readable recording medium according to claim 10, wherein the program further allows the computer to function as a transmission interval storage unit that stores a transmission interval for transmitting information on the setting change request,
in case of transmitting information on a setting change request to a device, the setting request transmitting unit specifies a transmission interval from transmission of the information on the setting change request transmitted to the device just previously, and transmits information on a setting change to the device upon elapse of a time equal to or greater than the transmission interval when the specified transmission interval is not equal to or greater than the transmission interval stored in the transmission interval storage unit.
